(19) United States
(12) Patent Application Publication
(10) Pub. No.: US 2003/0128509 A1
(43) Pub. Date: Jul. 10, 2003

(54) Bios controlled cooling for computer systems

(75) Inventor: Pascal Oudet, Goncelin (FR)

Correspondence Address: HEWLETT-PACKARD COMPANY, Intellectual Property Administration, P.O. Box 272400, Fort Collins, CO, 80527-2400, US

(73) Assignee: HEWLETT-PACKARD COMPANY

(21) Appl. No.: 10/134,160

(22) Filed: Apr. 25, 2002

(30) Foreign Application Priority Data
Jan. 4, 2002 (EP) 02354003.2

(51) Int. Cl. G06F 1/20

(52) U.S. Cl. 361/687; 700/300

(57) ABSTRACT

A computer device cooling system controls a cooling fan (190) based on components in the computer device (100) and packaging of the computer device (100). A BIOS (125) of the computer device (100) identifies the components of the computer device (100), which include a microprocessor (110), memory configuration (120), peripheral cards (150) and the like. The BIOS (125) also identifies the packaging, which includes the housing, power supply, storage device and the like. Based on the identified packaging and the components, the BIOS (125) selects a threshold temperature and sets a reference voltage in a fan control circuit (180) associated. The reference voltage is associated with the threshold temperature. The fan control circuit (180) detects the temperature of the computer device (100) and outputs a voltage associated with the detected temperature. The fan control circuit (180) compares the voltage associated with the detected temperature with the reference voltage and increases the speed of the fan (190) in response to the voltage being greater than the reference voltage.

### FIELD OF THE INVENTION

The invention relates to the field of computers, and more specifically to the control of computer fans.

### BACKGROUND OF THE INVENTION

Most computer systems or similar electronic devices comprise air cooling systems, with one or more fans. These fans are typically operated by DC controlled motors. One of the problems encountered with such fans is the problem of the noise of the motor running the fans, and the noise of the fan itself.

Conventional cooling systems are designed to regulate temperature of a computer system based on the heat dissipation for a particular configuration (e.g., processor, memory system. video card, and the like) for the computer system. Also, conventional cooling systems control fan speed with fixed hardware that does not allow changing the profile of the fan speed. Accordingly, the hardware is configured to regulate the fan speed for a computer system configuration that generates the most amount of heat. However, only a small percentage of users may actually utilize this configuration. Instead, a large percentage of the users may utilize less powerful computer systems that generate less heat, but have a cooling system designed for the more powerful systems. Therefore, a large percentage of the users may unnecessarily accommodate noisy cooling systems.

Several solutions to this problem have already been proposed. For example, prior art cooling systems utilize a heat sensing device to regulate the fan speed for the cooling system.

U.S. Pat. No. 5,249,741 discloses a computer system with fans, where the required fan speed is stored in a register; the stored digital value is converted to an analog value for driving a power supply unit. The power supply unit provides to the fan motor a DC voltage representative of the analog value supplied by the digital analog converter. The speed value of a fan is determined at boot time based on the cooling requirements of each of the components of the computer system, the cooling requirements being stored in the system. There is no provision in this document for changing the speed value for a fan during operation of the computer system.

U.S. Pat. No. 2,991,405 teaches the use of a thermistor connected to the base of a transistor for controlling the current supplied through the transistor to a motor in a temperature control system.

U.S. Pat. No. 5,687,079 discloses a computer fan control circuit; it suggests controlling the speed of the fan in a computer, according to the temperature of the ambient air detected by a thermistor. The current supplied to the motor operating the fan is controlled by a transistor. The base of the transistor is connected to a circuit comprising a thermistor. A low temperature voltage divider provides a constant low voltage to the motor when air temperature is below 28° C. A high temperature voltage divider provides a constant high voltage to the motor when air temperature is above 40° C. Thus, voltage supplied to the motor is constant below 28° C., increases linearly, and is again constant above 40° C.

These prior art circuits suffer a number of drawbacks. Some are not based on common components, and are therefore costly to manufacture. They do not ensure that the fan will start, when operated at the minimal speed.

For a temperature control of the type shown in U.S. Pat. No. 5,687,079, three independent parameters need to be set. The first is the minimal fan speed Vmin. The second is the lower temperature Tmin below which the fan will operate at its minimum speed. The third one is the upper temperature Tmax above which the fan will operate at its maximum speed. The prior art circuits do not allow easy control of these three parameters; however, these parameters need to be adapted to the type of computer system in which the fan is used.

In addition, the maximum voltage supplied to the fan motor should preferably be as close as possible to the maximum available voltage.

Finally, it is useful that the fan motor be driven as accurately as possible.

### SUMMARY OF THE INVENTION

An aspect of the invention is to provide a cooling system for a computer device. The cooling system comprises a cooling fan; a fan control circuit configured to control the speed of the cooling fan; and a system BIOS configured to adjust at least one parameter of the fan control circuit. The at least one parameter affects control of the fan speed.

Another aspect of the invention is to provide a cooling fan control circuit configured to control a speed of a cooling fan. The circuit comprises a comparator comparing a reference voltage to a voltage relative to a measured temperature; a parameter adjustment circuit configured to adjust the reference voltage; and a motor connected to the cooling fan. The motor increases the speed of the cooling fan in response to the voltage relative to the measured temperature being greater than the reference voltage.

Another aspect of the invention includes a method of controlling a cooling fan in a computer device. The cooling fan is controlled by a cooling fan circuit configured to increase the speed of the cooling fan when a temperature of the computer device is greater than a threshold. The method comprises steps of identifying components in the computer device; identifying packaging of the computer device; and selecting the threshold based on the identified components and packaging.

The methods of the present invention include steps that may be performed by computer-executable instructions executing on a computer-readable medium.

In comparison to known prior art, the invention provides automatic adjustment of a threshold temperature based on the components in the computer device and the packaging of the computer device. Typically, the threshold temperature is the same for different configurations of the computer device, which may result in a cooling fan being operated at unnecessarily high speeds, creating a noisy computer device. The invention controls the speed of the cooling fan, such that cooling fan may not be unnecessarily operated at high speeds. This can result in a quieter computer device. Those skilled in the art will appreciate these and other features and benefits of various embodiments of the invention upon reading the following detailed description of a preferred embodiment with reference to the below-listed drawings.

### BRIEF DESCRIPTION OF THE DRAWINGS

The present invention is illustrated by way of example and not limitation in the accompanying figures in which like numeral references refer to like elements, and wherein:

FIG. 1 illustrates an exemplary computer system employing principles of the invention;

FIG. 2 illustrates an exemplary thermal profile;

FIG. 3 illustrates a thermal table;

FIG. 4 illustrates an exemplary fan control circuit; and

FIG. 5 illustrates an exemplary method employing principles of the invention.

### DETAILED DESCRIPTION OF THE INVENTION

In the following detailed description, numerous specific details are set forth in order to provide a thorough understanding of the present invention. However, it will be apparent to one of ordinary skill in the art that these specific details need not be used to practice the present invention. In other instances, well known structures, interfaces, and processes have not been shown in detail in order not to unnecessarily obscure the present invention.

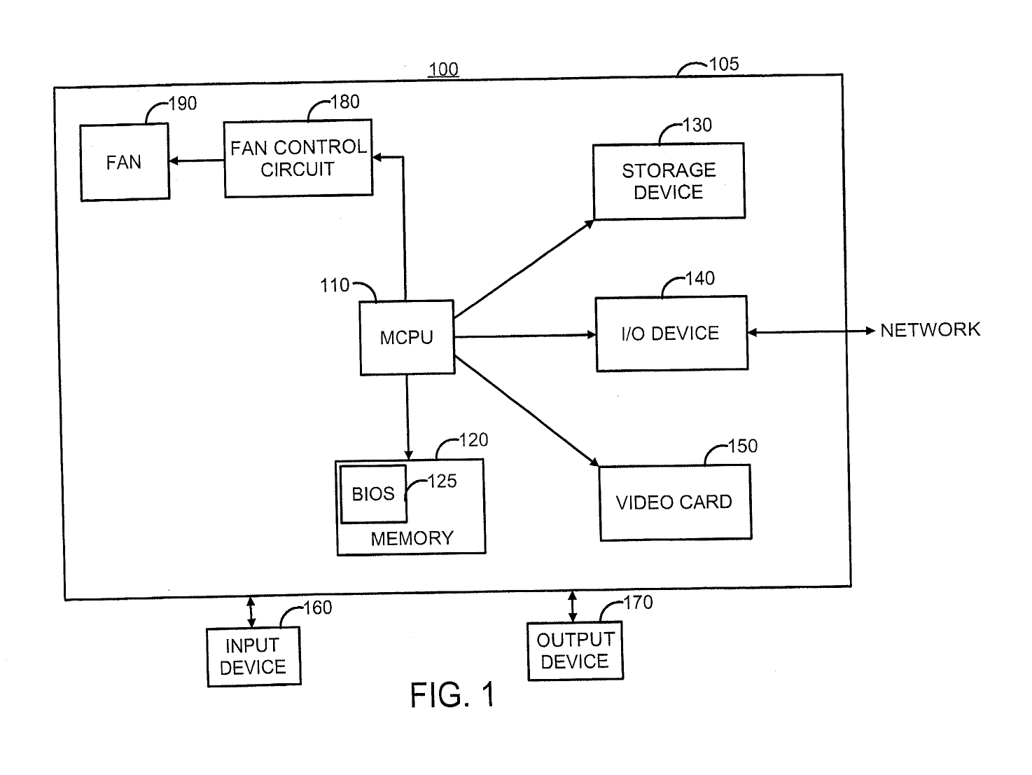

FIG. 1 illustrates an exemplary computer system 100 employing principles of the invention. The system 100 includes a microprocessor 110 connected to a memory 120, a storage device 130, an input/output (I/O) device 140, a video card 150, an input device 160 and an output device 170. The system 100 includes a housing 105. The housing, for example, may include a min-tower or other conventional housing.

The memory 120 may include RAM, ROM, EPROM, and the like. The memory 120 may store the system BIOS 125, operating system and other information. The storage device 130 may include a hard drive, ZIP drive, tape drive and/or any conventional storage device. The I/O device 140 may include a modem, network card or any conventional device operable to connect to a remote device via a network or other communication means. The system 100 may include one or more peripheral cards, such as the video card 150 and other peripheral cards (not shown) (e.g., a network card, a graphics accelerator card, etc.). Peripheral cards are easily added/removed from the system 100 to provide improved system performance and/or capability. The input device 160 may include conventional devices, such as a keyboard, mouse, and the like. The output device 170 may include a display, audio output device, and the like.

The microprocessor 110 is also connected to a fan control circuit 180 for controlling a cooling device, such as a cooling fan 190, that functions to dissipate heat in the system 100. The fan control circuit 180 is programmed by the microprocessor 110 to optimally control the fan 190 for a specific system configuration and a specific package configuration. The fan control circuit 180 may include a circuit operable to control the speed of the fan 190. The fan control circuit 180 may include a modified embodiment of the fan control circuit disclosed in co-pending U.S. patent application Ser. No. 09/291,897 (filed Apr. 14, 1999 and entitled “Fan Control Circuit”), which is herein incorporated by reference.

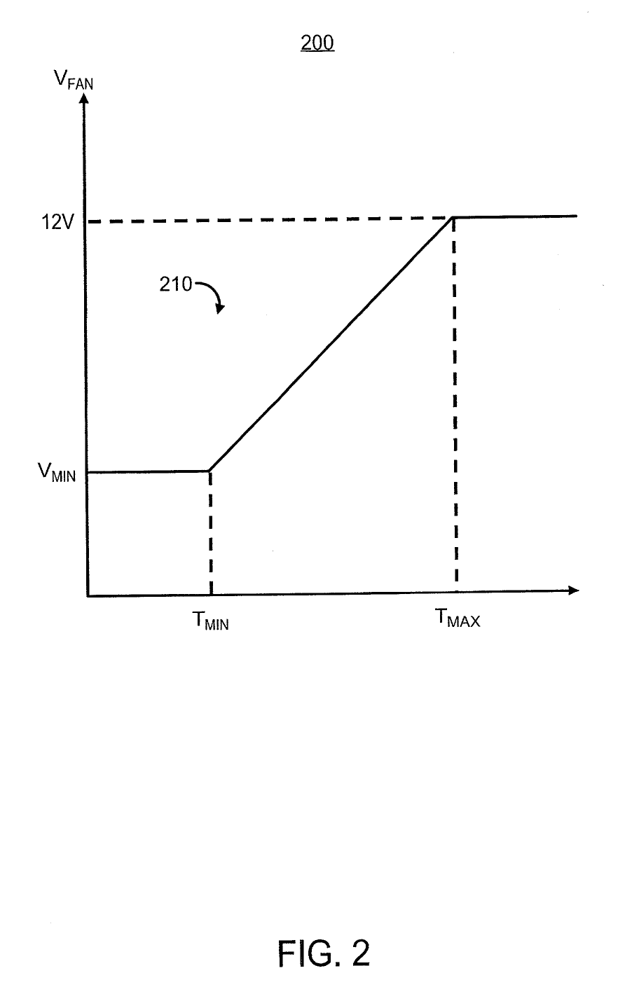

The fan control circuit 180 is operable to control the fan 190 in accordance with a thermal profile, which may be adjusted by the microprocessor 110. FIG. 2 illustrates an exemplary thermal profile 200. The thermal profile 200 includes a curve 210 of the voltage supplied to a motor controlling the speed of the fan 190. The vertical axis is the voltage, and the horizontal axis the temperature measured at a temperature sensor. Below a lower temperature Tmin, a constant voltage Vmin is supplied to the motor. Above a higher temperature Tmax, a constant voltage Vmax is supplied to the motor. Between Tmin and Tmax, the voltage supplied to the motor is substantially a linear function of the temperature, and varies between Vmin and Vmax.

For a personal computer system, the maximum voltage Vmax is preferably as close as possible to the maximum available voltage, which is 12 V in standard personal computer type computers. This allows the fan 190 to be operated at the maximum possible speed.

The other three parameters, Vmin, Tmin and Tmax may be adapted according to the cooling requirements of the different components of the computer system 100 and the packaging of the system 100.

In a preferred embodiment, the BIOS 125 executed by the microprocessor 110 controls Tmin based upon a system configuration and package configuration for the system 100. The system configuration includes the internal components of the computer system 100 that dissipate heat. The system configuration may include, but is not limited to, the microprocessor, the memory 120 and the peripheral cards in the system 100. For a personal computer system, the system configuration may include devices connected to the motherboard that dissipate a substantial amount of heat.

The package configuration may include the housing 105 of the system 100, the size of the fan 190, the power supply, the storage device 130 and possibly other devices that are typically standard in the system 100 and that affect heat dissipation and/or dissipate a relatively substantial amount of heat in the system 100. For a personal computer system, for example, one of two or three types of system configurations may be employed in each package configuration. For example, a computer system may include a package configuration having a laptop housing and a system configuration including a 1 GHz microprocessor. Alternatively, the same package system may be used with a system configuration having a 1.2 GHz microprocessor.

Upon start-up of the system 100, the BIOS 125 determines the system configuration and the package configuration for the system 100. For example, upon start-up the BIOS 125 determines whether all the components of in the system 100 are attached and operational. The BIOS 125 also identifies the microprocessor type/speed, the memory configuration, peripheral cards, package configuration information, etc. This information may be queried from the components of the system 100 and/or input by a user.

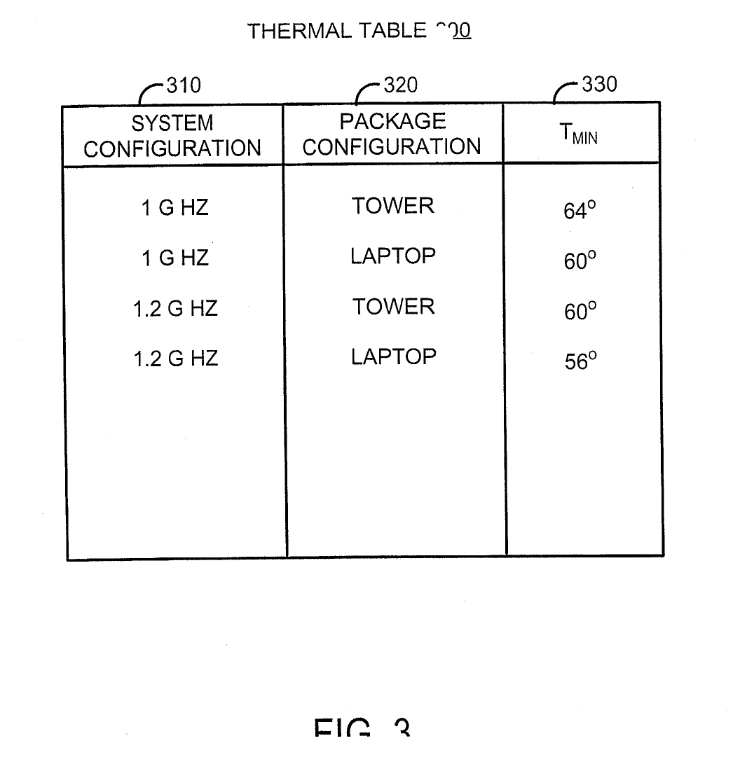

Based upon the system configuration and the package configuration, the BIOS 125 determines Tmin for the system 100. For example, the BIOS 125 uses the thermal table 300, shown in FIG. 3, to determine the setting for Tmin. The thermal table 300 may be stored in the system 100, such as in the memory 120. The thermal table 300 includes at least three columns. A first column 310 includes system configurations, a second column 320 includes package configurations, and a third column 330 includes Tmin. The BIOS 125 selects a Tmin for a particular system configuration and a particular package configuration. For example, a 1 GHz system configuration in a tower package corresponds to a Tmin of sixty-four degrees.

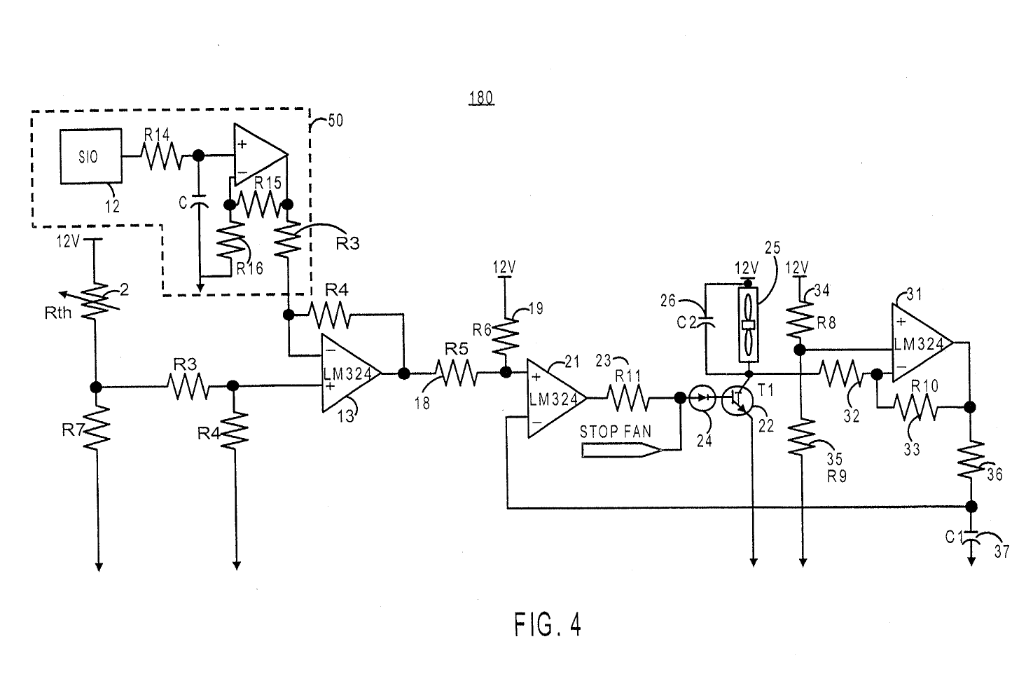

After Tmin is selected by the BIOS 125, the BIOS 125 regulates the fan control circuit 180 to control the fan 190 based on the selected Tmin. FIG. 4 illustrates a preferred embodiment of the fan control circuit 180, which may be regulated by the microprocessor 110 executing the BIOS 125. The fan control circuit 180 includes many components of the fan control circuit disclosed in U.S. patent application Ser. No. 09/291,897 and a circuit 50, described below, for adjusting the temperature Tmin.

A sensor amplifier is based on an operational amplifier 13, used as a comparator. The NTC thermistor 2 is connected in series with a resistor R7 referenced as 10 between Vcc and ground. Vcc may be 12 V for a personal computer system. The sensor amplifier detects when the temperature of the system 100 rises above Tmin. Then, the voltage applied to the motor 25 is increased to increase the speed of the fan 190 for cooling the system 100.

Tmin may be adjusted by the circuit 50 connected to the negative input of the operational amplifier 13 in the fan control circuit 180. At start-up, the BIOS 125 programs the pulse width modulation (PWM) ratio to issue the appropriate reference voltage to the fan control circuit 180. The voltage is filtered through R14*C in the circuit 50. R14 and C are chosen depending on the PWM frequency of the signal output by the super I/O (SIO) 12. As this voltage is usually 0-5 V or 0-3.3 V, it must be amplified to the 0-12 V range.

The SIO 12 is typically used in PCs and commonly controls I/O for a keyboard, mouse, floppy drive, input and output ports (e.g., serial, parallel, etc.). The SIO 12 also performs several other functions, such as general purpose inputs and outputs, and can act as a signal generator, such as a PWM signal generator. The duration of pulse output by the SIO 12 may be adjusted, for example, by the processor 110, such that circuit 50 can output a voltage (Vtmin) associated with a Tmin identified from the thermal table 300. Therefore, the circuit 50 may generate a variable voltage from a digital circuit by filtering the PWM signal output by the SIO 12 with R14*C. The SIO 12 may include a conventional SIO available from a variety of manufacturers. It will be apparent to one of ordinary skill in the art that the thermal table 300, in column 330, may include duty cycles (e.g., PWM ratios) for a PWM signal output by the SIO 12 that are associated with the temperatures Tmin. The variable duty cycles will cause the circuit 50 to generate variable reference voltages Vtmin output by the circuit 50.

The positive input of the amplifier 13 is connected between the thermistor 2 and the resistor R7, through a resistor 14 having a resistance R3. The positive input is also connected to the ground through a resistor 15 having a resistance R4.

The voltage Vout at the output of the amplifier 13 is given by the following formula

Vout=Vtherm−Vtmin,

wherein Vtherm is the voltage associated with the temperature detected by the thermistor 2. This formula can be rewritten as follows:

$$Vout = Vcc \frac{R4}{R3} \cdot \frac{R7}{R7 + NTC} - Vt min$$

This formula represents Vout when the resistance NTC of the thermistor 2 is sufficiently low that R7/(R7+NTC) is higher than the output voltage of the circuit 50 (i.e., Vtherm>Vtmin). Otherwise, the output of the amplifier is grounded (e.g., Vtmin>Vtherm). The comparator (i.e., the amplifier 13) therefore compares Vtherm with a reference voltage Vtmin given by the output voltage of the circuit 50. The comparator may then output a difference signal Vout representative of the difference between these two voltages.

The slope dV/dT of the voltage curve 210 (FIG. 2) may be adjusted using the resistors 14, 15, 16 and 17, so as to adjust the ratio R4/R3. The output of the amplifier 13 is further connected to Vcc by two resistors 18 and 19 in series, having respective resistance of R5 and R6. These two resistors add a minimum voltage Vmin to the output of the first amplifier; Vmin may be adjusted using the resistors 18 and 19, so as to adjust the resistance R5 and R6. The two resistor thus act as means for adding a lower voltage Vmin to the output of the comparator.

The voltage Vfan+ to be applied to the fan motor is available between the resistors 18 and 19, and is given by the following formula:

$$Vfan \text{+} = Vcc \frac{R5}{R5 + R6} + Vcc \frac{R4}{R3} \cdot \frac{R6}{R5 + R6} \cdot \frac{R7}{R7 + NTC} - Vt min$$

The circuit 180 facilitates setting of the independent parameters of the voltage curve 210 of FIG. 2. As explained above, Vmin is equal to Vcc*R5/(R5+R6), and may be set by adjusting the values R5 and R6 of the resistors; the minimum value is chosen so as to have the minimum noise in the computer. The value Tmin may be set by the circuit 50 and the BIOS 125.

The slope dV/dT is adjusted by varying the values of the resistance R4 and R3. Indeed, as appears from the formula giving Vfan+, once R5, R6 and R7 are set, voltage Vfan+ has a slope that depends linearly on the ratio R4/R3.

An amplifier 21 is used as subtractor for the feedback loop control of the fan motor 25; the positive input of the amplifier is connected between the resistors 18 and 19; it receives the voltage Vfan+. The negative input of the amplifier receives the voltage provided by the feedback loop, as explained below.

The output of the amplifier 21 is connected to the base of a power transistor T1, referenced 22, through a resistor 23 and a diode 24. The fan motor 25 is connected between Vcc and the collector of the transistor 22, while the emitter of the transistor 22 is grounded. Thus, the voltage applied to the fan motor 25 is controlled by the power transistor 22, according to the sign of the difference between the voltages Vfan+ and Vfan− applied to the amplifier 21. A voltage from 6 V to 0 V is thus applied to the base of the transistor T1.

Preferably, the power transistor 22 is a NPN transistor, so as to reduce the voltage drop across the transistor. The saturation voltage between the collector and emitter of the transistor may have a value as low as 0.2 V, so that the maximum voltage applied to the motor is near to Vcc. This transistor may be a 500 mA/3 W transistor for large fans, or a 250 mA/1.5 W transistor for small fans.

In addition, if it is necessary to be able to suspend the motor of the fan, there is provided a second transistor T2 referenced 28. The collector of the transistor is connected between the resistor 23 and the diode 24. The emitter of the transistor is grounded, and the base of the transistor is connected to the stop fan input, through a load resistor 29, e.g. a 1 kOhm resistor. The transistor may be a FET, or an open collector buffer.

In normal operation, the stop fan input is at a logical low level, so that the transistor T2 is blocked; in this case, the power transistor T1 is controlled by the voltage applied to its base by the amplifier 21. When a logical high level signal is applied to the stop fan input, the transistor T2 is closed, and the base of the power transistor T1 is brought to the ground, so that the power transistor is blocked. This stops the fan motor.

Diode 24 ensures that the power transistor is blocked when the stop fan input is asserted. It may be done without according to the specifications of the power transistor.

According to one feature of the invention, a capacitor 26 with a capacitance C2 is connected in parallel to the motor. This capacitor avoids low speed oscillation of the circuit, and reduces noise. The value of the capacitance C2 is chosen according to the resistance Rm of the motor; a value of the capacitance C2 around 22 microF is appropriate.

The structure of the feedback loop is the following. The feedback loop comprises a third amplifier 31; the negative input of the amplifier 31 is connected to the collector of the power amplifier through a resistor referenced 32. A resistor R8 referenced 34 is connected in series with a resistor R9 reference 35 between Vcc and ground. The positive input of the amplifier 31 is connected between the resistors 34 and 35. A feedback resistor RIO referenced 33 is connected between the negative input of the amplifier and its output.

The output of the amplifier 31 is connected through a resistor R12 referenced 36 to the negative input of the second amplifier 21. In addition, the negative input of the amplifier is grounded by a capacitor 37 having a capacitance C1.

The voltage Vfan− applied to the negative input of the amplifier 21 by the feedback loop is given by the following formula:

$$Vfan \text{-} = Vcc \cdot ( 1 - \frac{2 R9}{R8 + R9} )$$

The feedback loop thus withdraws from the voltage applied to the motor an offset determined by the resistance R8 and R9. This allows proper operation of the circuit, even if the amplifier 21 of the fan command cannot manage orders up to Vcc, but only below this value. In the case where Vcc is 12 V, and when the amplifier is a LM324, it may only manage input voltages up to 10.5 V. The offset of the feedback loop makes it possible to apply a 12 V voltage to the fan motor, even though the amplifier 21 only accepts voltages up to 10.5 V. Thus, the feedback loop compensates for the difference between the highest voltage applied to the fan motor and the highest voltage applied to the fan command amplifier 21.

The resistor 36 and the capacitor 37 ensure that the voltage applied to the motor when it is started is near to Vcc. This ensures that the motor will start; in some cases, applying Vmin only to the motor could have the effect of preventing the motor from starting. Thus, a Vcc pulse is applied to the motor when it is started; the duration of the pulse is set by the value of the time constant R12.C1.

For the setting of the parameters of the circuit, the thermal engineer may proceed as follows: first, according to the specifications of the amplifier 21, the value of the resistance R8 and R9 of resistors 34 and 35 are determined, so as to compensate the possible maximum value of voltage accepted by the amplifier.

At the same time, the resistance R12 of resistor 36 and the capacitance C1 may be chosen, so that the time constant R12.C1 is sufficient to ensure that the fan motor will start. A time constant of 0.5s or 1s is appropriate.

The values of Tmin may then be set, using the circuit 50. The values Vmin and the slope dV/dT may also be set, using the resistance of the various resistors, as explained above.

The following components may be used for the circuit of FIG. 4. The amplifiers 13, 21 and 31 may be amplifiers sold under the reference LM 324 by NS, SGS, TI or other suppliers. The fan motor may be any 12 V model such as those provided by Delta or NMB. The other components are usual passive components.

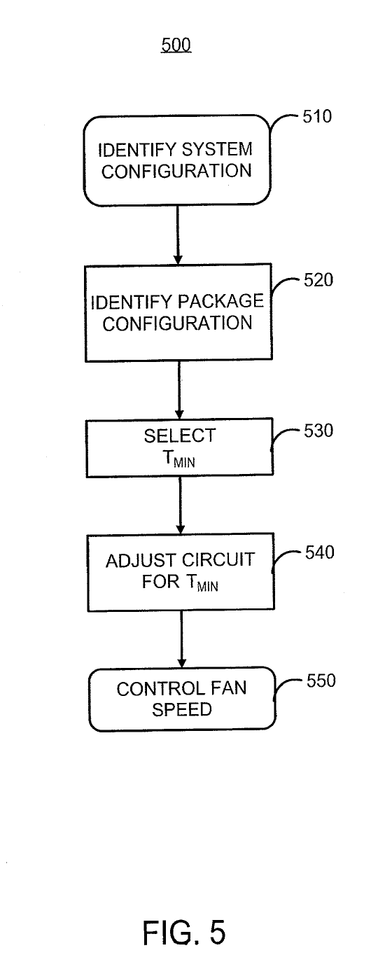

FIG. 5 illustrates a flow chart of an exemplary method 500 according to an embodiment of the invention. In step 510, the BIOS 125 identifies the system configuration of the system 100. In step 520, the BIOS 125 identifies the package configuration of the system 100. In step 530, the BIOS 125 queries the thermal table 200 to select Tmin based upon the identified system configuration and package configuration. In step 540, the BIOS 125 controls the circuit 50 to adjust Tmin to the selected Tmin for the fan control circuit 180. In step 550, the fan 190 is controlled based on the adjusted Tmin and other parameters making up the thermal profile. For example, the slope of the thermal profile and Tmax are also set by the fan control circuit 180, and the fan control circuit 180 controls the fan 190 based on the thermal profile and the detected temperature of the system 100.

Certain steps in the method 500 may be performed in different orders. For example, step 520 may be performed prior to step 510. Also, the computer system 100 is not limited to a personal computer system, and the invention may be applied to other computer systems, such as servers and other networking equipment, mainframes, work stations, and the like.

While this invention has been described in conjunction with the specific embodiments thereof, it is evident that many alternatives, modifications and variations will be apparent to those skilled in the art. There are changes that may be made without departing from the spirit and scope of the invention.

1. A cooling system for a computer device (100), the cooling system comprising:
a cooling fan (190);
a fan control circuit (180) configured to control the speed of the cooling fan (190); and
a system BIOS (125) configured to adjust at least one parameter of the fan control circuit (180), the at least one parameter affecting control of the fan speed.

2. The cooling system of claim 1, wherein the fan control circuit (180) includes a temperature sensor (2) sensing the temperature of the computer device (100), the fan control circuit (180) being configured to increase the speed of the cooling fan (190) in response to temperature sensed by the temperature sensor (2) being greater than a threshold.

3. The cooling system of claim 2, wherein the at least one parameter affects a value of the threshold.

4. The cooling system of claim 1, wherein the BIOS (125) identifies components in the computer device (100) and identifies packaging of the computer device (100) to determine an amount of adjustment of the at least one parameter.

5. The cooling system of claim 1, wherein the BIOS (125) programs an adjustable voltage to adjust the at least one parameter.

6. A method of controlling a cooling fan (190) in a computer device (100), the cooling fan (190) being controlled by a cooling fan circuit (180) configured to increase the speed of the cooling fan (190) when a temperature of the computer device (100) is greater than a threshold, the method comprising steps of:
identifying components in the computer device (100);
identifying packaging of the computer device (100); and
selecting the threshold based on the identified components and packaging.

7. The method of claim 6, further comprising the fan control circuit (180) adjusting a reference voltage based on the selected threshold.

8. The method of claim 7, further comprising steps of:
sensing the temperature of the computer device (100);
converting the sensed temperature to a voltage;
comparing the voltage to the reference voltage; and
increasing the speed of the fan (190) in response to the voltage being greater than the reference voltage.

9. The method of claim 10, wherein a BIOS (125) in the computer device (100) performs the steps of identifying components and identifying packaging.

10. The method of claim 6, wherein the packaging comprises housing for the computer device (100).
